(19) United States
(12) Patent Application Publication
(10) Pub. No.: US 2015/0112090 A1
(43) Pub. Date: Apr. 23, 2015

(54) USE OF ORGANIC ACIDS TO IMPROVE LIPID STABILITY

(71) Applicant: ARCHER DANIELS MIDLAND COMPANY, Decatur, IL (US)

(72) Inventors: Shireen Baseeth, Decatur, IL (US); Jolene Hoke, Bethany, IL (US); Scott Tilton, Maroa, IL (US)

(73) Assignee: ARCHER DAINELS MIDLAND COMPANY, Decatur, IL (US)

(21) Appl. No.: 14/402,714

(22) PCT Filed: Jun. 7, 2013
(86) PCT No.: PCT/US13/44632

§ 371 Date: Nov. 21, 2014

Related U.S. Application Data
(60) Provisional application No. 61/656,660, filed on Jun. 7, 2012.

(51) Int. Cl. C11B 5/00

(52) U.S. Cl. CPC C11B 5/0028
USPC 554/2

(57) ABSTRACT

Methods for preventing oxidation in lipids using organic acids are disclosed. Compositions including the lipids are also disclosed.

### TECHNICAL FIELD

The present invention relates generally to lipids in animal feeds. More particularly, the present invention relates to compositions and uses thereof for stabilizing lipids.

### BACKGROUND OF THE INVENTION

Fats and oils are used as concentrated sources of calories in livestock and pet food products. Animal and poultry fats tend to be used more often than vegetable oils in animal feeds due to cost. As animal feed grade products, such animal and poultry fats are often lower in purity than food grade products. Such lower grade products have greater potential for lipid oxidation which is a reaction that occurs between unsaturated lipids and oxygen. Lipid oxidation can be accelerated by light, heat, metals, or other compounds, either alone or in combination. The oxidation creates undesirable flavors and odors, and may even lead to rancidity.

The undesirable flavors and odors may result from a number of different reaction products which are not well understood. For instance, the complexity of the natural fats and oils, as well as the number of different possible reaction pathways that the oxidative processes may take leads to a myriad of possibilities. What is known is that oxidative rancidity occurs from the oxidation of double bonds in unsaturated fatty acids where peroxides or hydro-peroxides are formed as primary oxidation products. Thus, the peroxide value (PV) is one trait used to assess the quality of fats or oils. However, because peroxides are unstable and may readily undergo further reactions, a low PV is not necessarily a good marker for identifying high quality fats and oils. For instance, a lipid source may have a high PV level which subsequently declines due to the degradation of peroxides into secondary reaction products such as aldehydes, ketones, and lower molecular weight acids.

Another method of measuring fat quality is the Oil Stability Index (OSI). The OSI is an indicator of the relative resistance of fats and oils to oxidation. As lipids degrade, the rate of oxidation is slow until the resistance to oxidation is overcome. This period is referred to as the oxidation induction period. After the oxidation induction period, the rate of fatty acid oxidation drastically increases. The duration of the oxidation induction period varies with the degree of unsaturation, presence of antioxidants, and/or storage conditions. The duration of the oxidative induction period is the value that is reported as the OSI value for the fat or oil. The OSI value also is an indicator of shelf life since it measures resistance to oxidation, whereas measuring peroxide values and free fatty acid levels are point in time measurements that reflect how good or bad a fat source is at a given time.

In North America, feed grade fats and oils are labeled with total fatty acid content, unsaponifiable matter, and insoluble purities. Maximum free fatty acid content and moisture are typically guaranteed and if an antioxidant is added to the fat, the common name of the antioxidant should appear on the label followed by the phrase “used as a preservative.” Many antioxidants are used in the feed and food industries and are divided into two main categories, primary and secondary antioxidants.

Primary antioxidants act by interrupting the free radical chain of oxidative reactions. This is done by donating hydrogen from phenolic hydroxyl groups to form stabile free radicals that do not initiate or propagate further oxidation. Examples of primary antioxidants include butylated hydroxyanisol (BHA), butylated hydroxytoluene (BHT), propyl gallate (PG), tertbutylhydroquinone (TBHQ), α-tocopherol, β-tocopherol, γ-tocopherol, ε-tocopherol, mixed tocopherols, Vitamin A, and Vitamin E.

Secondary antioxidants trap radicals, chelate metals, regenerate primary antioxidants, or act as emulsifying agents. Metal inactivators or chelators act by deactivating metal ions and prevent the metal ions from initiating oxidation and decomposing hydroperoxides, leading to the prevention of aldehyde formation. Metal chelators include citric acid, phosphoric acid, ethylenediamine tetraacetic acid (EDTA), 8-hydroxy-quinoline, and ascorbic acid. However, these acids are poorly soluble in lipid environments.

The various primary and secondary antioxidants may also be used in various combinations in multicomponent antioxidant systems which have enhanced abilities to reduce oxidation and prevent the development of rancidity. In some instances, such combinations are synergistic such as the combination of natural tocopherols and citric acid as discussed in the article “Frankel, E. N., P. M. Cooney, H. A. Moser, J. C. Cowan, and C. D. Evans, 1959, Effect of antioxidants and metal inactivators in tocopherol-free soybean oil, Fette Seifen, Anstrichm 10:1036.” The article reports that the oxidative stability of the oil was exponentially greater for the combination of tocopherol and citric acid as compared to the tocopherol or citric acid individually.

Since fats and oils are routinely mixed into or sprayed onto animal feeds or pet foods that are packaged and distributed via warehouses, dealers, and retail sales locations, it's important for the lipids to be stable for long periods of time, such as for at least six months, up to one year, or even up to eighteen months.

While antioxidants provide stability and enhanced shelf life for various lipids, a need exists for ways to prevent oxidation in lipids in order to enhance the quality of lipids.

### SUMMARY OF THE INVENTION

In each of its various embodiments, the present invention fulfills this need and discloses uses of organic acids for preventing oxidation and/or improving the stability of fats and oils.

In one embodiment, a method for preventing oxidation in an animal based lipid comprises adding an organic acid to the animal based lipid.

In a further embodiment, a method for preventing oxidation in a lipid comprises mixing a lipid soluble organic acid and lecithin with the lipid.

In another embodiment, a lipid containing composition comprises a lipid soluble organic acid and a lipid. The lipid containing composition has an improved oxidative stability as compared to a lipid containing composition not including the lipid soluble organic acid.

### BRIEF DESCRIPTION OF THE DRAWINGS

FIG. 1 shows OSI values of commercially available fats.

FIG. 2 shows the ability of one embodiment of the present invention to improve the oxidative stability of a fat.

### DETAILED DESCRIPTION OF THE INVENTION

In the present application, including the claims, other than in the operating examples or where otherwise indicated, all numbers expressing quantities or characteristics are to be understood as being modified in all instances by the term “about”. Accordingly, unless indicated to the contrary, any numerical parameters set forth in the following description may vary depending on standard deviation or variances in measuring techniques and/or the desired properties one seeks to obtain in the compositions and methods according to the present disclosure. At the very least, and not as an attempt to limit the application of the doctrine of equivalents to the scope of the claims, each numerical parameter described in the present description should at least be construed in light of the number of reported significant digits and by applying ordinary rounding techniques.

Any patent, publication, or other disclosure material, in whole or in part, that is said to be incorporated by reference herein is incorporated herein only to the extent that the incorporated material does not conflict with existing definitions, statements, or other disclosure material set forth in this disclosure. As such, and to the extent necessary, the disclosure as set forth herein supersedes any conflicting material incorporated herein by reference. Any material, or portion thereof, that is said to be incorporated by reference herein, but which conflicts with existing definitions, statements, or other disclosure material set forth herein is only incorporated to the extent that no conflict arises between that incorporated material and the existing disclosure material.

In each of various embodiments, the present invention discloses compositions and methods for improving the stability of lipids. Uses of organic acids for such purposes are also disclosed. Such organic acids may act as lipid soluble metal chelating agents in fats and oils, and may bind free metals including, but not limited to, aluminum, phosphorus, sulfur, zinc, iron, magnesium, calcium, copper, sodium, potassium, and manganese, thus diminishing the ability of the free metals to react with fatty acids in the fats or oils. The addition of the organic acids may take place during the course of refining such lipids, during storage of the lipids, or being added to used oils, such as fryer oils, to extend the useful life of the lipid.

In one embodiment, the organic acid may be a polar acid that is miscible in lipid environments and the organic acid may act as a chelating agent. Such polar acids may have enhanced abilities to complex with metal ions in lipids.

In an additional embodiment, the organic acids may be added at an amount of 0.2-6% by weight.

In yet another embodiment, the lipid may be of an animal origin. Non-limiting examples of animal lipids are poultry fat, pork fat, choice white grease, yellow grease, beef fat, tallow, lard, fish oil, and butter fat. In yet a further embodiment, the lipid may be of a vegetable origin selected from the group consisting of flax seed oil, soybean oil, olive oil, corn oil, peanut oil, sesame oil, grape seed oil, almond oil, cashew oil, canola oil, cottonseed oil, sunflower oil, rice bran oil, wheat bran oil, palm oil, palm kernel oil, coconut oil, or soapstock from any of these oils.

In yet a further embodiment, the compositions of the present invention may be used to prevent oxidation in lipids in animal feeds. The lipids may be present in an oil or fat, or an animal-vegetable blend. In another embodiment, the lipids may be present in a high fat feed ingredient such as distillers grains, fish meal, rice bran, high fat product (HFP), full fat soy flour, or other high fat feed ingredient.

In yet another embodiment, it has been unexpectedly found that a combination of lecithin and an organic acid is able to prevent oxidation in lipids more effectively than the organic acid by itself.

The following exemplary, non-limiting examples are provided to further describe the embodiments presented herein. Those having ordinary skill in the art will appreciate that variations of these Examples are possible within the scope of the invention.

### EXAMPLE 1

This Example evaluated the effect of adding lactic acid to a poultry fat. 2.00% of 88% purity lactic acid was added to samples of commercially available poultry fat stabilized with tocopherols as an antioxidant. Two samples of poultry fat were obtained and each sample was split into four subsamples. The lactic acid was added to two subsamples of each sample, and the remaining subsamples from each fat sample were used as a control. All of the samples were evaluated for oxidative stability index (OSI) determination and the samples containing the lactic acid were found to have a 2.4 fold increase in time to induction as compared to the control samples. Results of this Example are shown in Table 1. As indicated in Table 1, the addition of lactic acid increased the induction period from, on average, from 2.66 hours to 6.44 hours.

TABLE 1
Effect of lactic acid addition to poultry fat containing tocopherol as an
antioxidant on Time to Induction of Oxidation using OSI testing at 85° C.

| Replication | Control, hours | Lactic Acid added, hours |
|---|---|---|
| 1 | 2.63 | 6.28 |
| 2 | 2.95 | 6.38 |
| 3 | 2.50 | 6.53 |
| 4 | 2.55 | 6.58 |
| Average | 2.66 | 6.44 |

This increase in OSI value is indicative of an increased resistance to oxidative rancidity and improved shelf life. The samples of poultry fat with added lactic acid also appeared to be more flowable at room temperatures. Samples with the lactic acid added followed by mixing also appeared to contain a minor amount of dark colored sediment. This dark colored sediment appears to be from mineral complexing, resulting in improved OSI values and flowability. However, the formation of such sediment did not appear when the lactic acid was added to the fat during the mixing procedure.

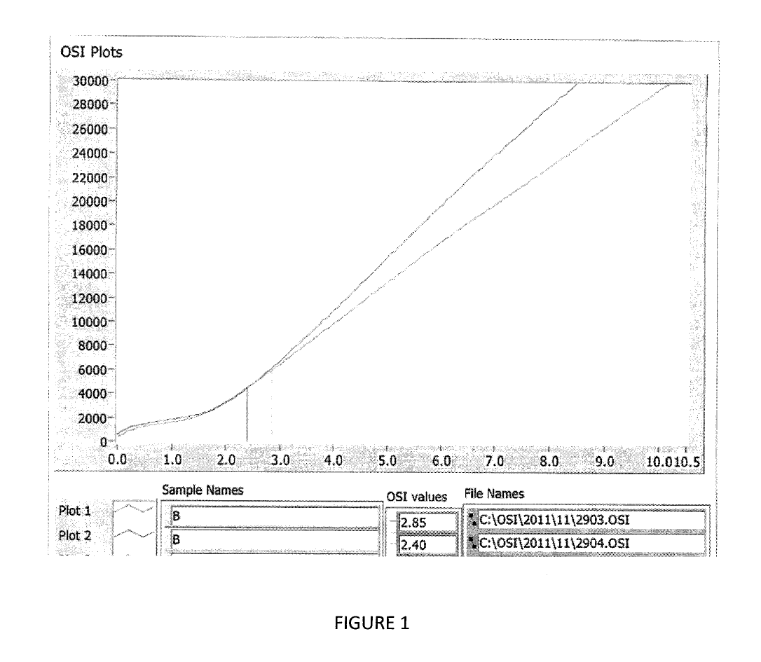

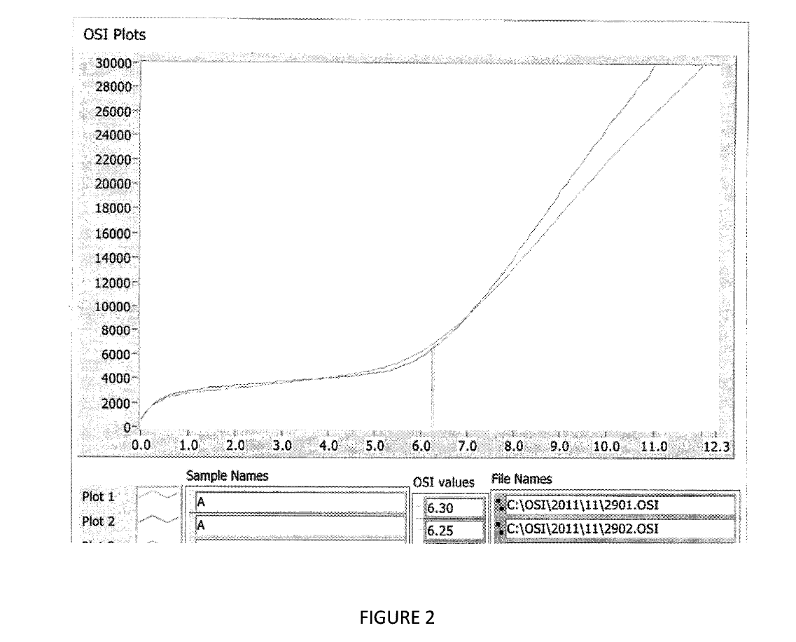

FIG. 1 shows the OSI graph for the poultry fat samples without added lactic acid, and FIG. 2 shows the OSI graph for the poultry fat samples with the added lactic acid.

### EXAMPLE 2

A number of evaluations were performed using various dosages or concentrations of lactic acid, different fat sources, and different temperatures in order to assess the ability of lactic acid to provide oxidative stability. The ability of the various concentrations of lactic acid to provide oxidative stability on poultry fat containing mixed tocopherols at 85° C. was examined. The concentrations of lactic acid and OSI are reported in Table 2. The ability of various concentrations of lactic acid for oxidative stability was also evaluated on choice white grease containing BHA and BHT at 110° C. The results are presented in Table 2. Since the flash point of lactic acid is 110° C., there was an initial increase in conductivity of the samples as excess lactic acid flashed off, but clear inflection points were discernible for the prediction of OSI values.

TABLE 2
Effect of different concentrations of lactic acid on OSI values for
poultry fat containing mixed tocopherols at 85° C. and on OSI
values for choice white grease containing BHA and BHT at 110° C.

| Lactic acid concentration (%) | Poultry fat OSI | Choice white grease OSI |
|---|---|---|
| 0.0 (control) | 0.12 | 5.13 |
| 0.2 | 4.13 | 5.00 |
| 0.4 | 3.60 | 6.05 |
| 0.6 | 3.85 | 5.80 |
| 0.8 | 3.61 | 6.60 |
| 1.0 | 3.43 | 7.02 |
| 1.5 | 5.28 | 8.43 |
| 2.0 | 4.80 | 8.58 |
| 3.0 | N/A | 9.17 |
| 4.0 | N/A | 9.15 |

To confirm the initial increases in conductivity of the samples observed with the OSI at 110° C. were due to a loss of lactic acid from the sample, and not due to changes in fat stability, a Food Stability Analyzer was used to evaluate the stability of choice white grease at 50° C. Due to the reduced temperature utilized by the Food Stability Analyzer, it was necessary to add a catalyst to the sample to accelerate lipid oxidation. 100% hemin chloride (available from Calbiochem, a division of Merck, Darmstadt, Germany) was added to the samples at a rate of 0.10 g to tubes having 2 g of choice white grease and analysis was performed with the Food Stability Analyzer. The results and concentrations tested are shown in Table 3.

TABLE 3
Stability values of lactic acid in choice white grease at 50° C. measured
with Food Stability Analyzer.

| Lactic Acid Concentration (%) | Stability values |
|---|---|
| 0.0 (control) | 0.99 |
| 1.0 | 21.23 |
| 2.0 | 41.65 |
| 3.0 | 55.73 |
| 4.0 | 66.00 |
| 5.0 | 69.58 |

The values of Table 3 indicate that lactic acid is helping prevent the oxidation of fatty acids, possibly by binding the free iron from the catalyst.

The fats that were evaluated included primary antioxidants. Thus, such fats were already substantially improved as compared to fats that do not include such primary antioxidants. Thus, the use of the organic acids described herein provide significant additional antioxidant effects and serves as a good combination with primary antioxidants including, but not limited to, mixed tocopherols, BHA, BHT, PG, TBHQ, ascorbyl palmitate, and combinations of any thereof, thus forming a combined antioxidant product. In other embodiments, the organic acids may be combined with polar antioxidants including, but not limited to citric acids or salts thereof; ascorbic acid or salts thereof; plant extracts such as green tea, rosemary, sage, thyme, oregano, cloves, or berry; or combinations of any thereof.

### EXAMPLE 3

Acetic acid, butyric acid, propionic acid, succinic acid, citric acid, fumaric acid, and malic acid were evaluated for their ability to prevent oxidation in lipids.

Acetic, butyric, and propionic acids were added at 2% w/w to a sample of poultry fat and analyzed for OSI at 85° C. The results are presented in Table 4. As Table 4 illustrates, the tested organic acids were not effective at preventing oxidation in poultry fat.

TABLE 4
Table 4. OSI of various organic acids.

| Organic acid | OSI value (hours) |
|---|---|
| Control, no acid | 0.12 |
| Acetic | 0.0 |
| Butyric | 0.15 |
| Propionic | 0.10 |

Succinic, citric, fumaric, and malic acids were added at 2% w/w to a sample of choice white grease and analyzed for OSI at 110° C. The powdered acids were liquefied in distilled water and added to the choice white grease at 2%. The results are presented in Table 5. The powdered acids were poorly soluble in the lipids.

TABLE 5
OSI of various organic acids.

| Organic acid | OSI value (hours) |
|---|---|
| Control, no acid | 5.13 |
| Succinic | 6.73 |
| Citric | 8.00 |
| Fumaric | 8.43 |
| Malic | 8.28 |

### EXAMPLE 4

A fat soluble antioxidant blend was prepared by mixing 90% by weight YELKIN SS brand lecithin (available from Archer-Daniels-Midland Company, Decatur, Ill.) with 10% by weight of 88% strength lactic acid (available from Archer-Daniels-Midland Company, Decatur, Ill.) at room temperature with constant stirring for about thirty minutes. A clear, transparent lecithin-lactic acid blend was formed that had a low viscosity and was liquid in nature. The effective concentration of the lactic acid in the lecithin-lactic acid blend was 8% w/v.

The lecithin-lactic blend was added at 0.4% to a sample of choice white grease and analyzed for OSI at 110° C., providing an OSI of 14.4 as compared to 7.02 for 1% lactic acid without the lecithin as shown in Table 2.

### EXAMPLE 5

A fat soluble antioxidant blend was prepared by mixing 90% by weight YELKIN SS brand lecithin (available from Archer-Daniels-Midland Company, Decatur, Ill.) with 10% by weight of 88% strength citric acid (available from Archer-Daniels-Midland Company, Decatur, Ill.) at room temperature with constant stirring for about thirty minutes. A clear, lecithin-citric acid blend was formed that was viscous and formed a gel type network that was completely thermo-reversible. The effective concentration of the citric acid in the lecithin-citric acid blend was 8% w/v.

The lecithin-citric blend was melted to a liquid phase and added at 0.4% to a sample of choice white grease and analyzed for OSI at 110° C., providing an OSI of 11.3 compared to 8.0 for citric acid at 2% without the lecithin as shown in Table 5.

### EXAMPLE 6

A fat soluble antioxidant blend was prepared by mixing 68% by weight YELKIN SS brand lecithin (available from Archer-Daniels-Midland Company, Decatur, Ill.) with 16% by weight of 88% strength lactic acid (available from Archer-Daniels-Midland Company, Decatur, Ill.) at room temperature with constant stirring for about thirty minutes. To this blend, 16% by weight water was slowly added with mixing. A clear, transparent lecithin-lactic acid-was blend was formed that was liquid and had a low viscosity. The effective concentration of the lactic acid in the blend was 14% (w/v). To this blend, a polar antioxidant is added and is solubilized, and a synergistic combination of an antioxidant blend package is made.

The present invention has been described with reference to certain exemplary and illustrative embodiments, compositions and uses thereof. However, it will be recognized by persons having ordinary skill in the art that various substitutions, modifications or combinations of any of the exemplary embodiments may be made without departing from the scope of the invention. Thus, the invention is not limited by the description of the exemplary and illustrative embodiments, but rather by the appended claims.

1. A method for preventing oxidation in an animal based lipid, the method comprising:
adding an organic acid to the animal based lipid.

2. The method according to claim 1, further comprising mixing lecithin with the organic acid, the animal based lipid, or a combination thereof.

3. The method according to claim 1, wherein the organic acid is selected from the group consisting of lactic acid, succinic acid, citric acid, fumaric acid, malic acid, and combinations of any thereof.

4. The method according to claim 1, wherein the organic acid is added at an amount of 0.2-6% by weight of the animal based lipids.

5. The method according to claim 1, further comprising mixing a primary antioxidant with the animal based liquid.

6. The method according to claim 1, wherein the animal based lipid is poultry fat, white grease, yellow grease, beef fat, tallow, lard, pork fat, fish oil, or combinations of any thereof.

7. The method according to claim 1, further comprising incorporating the animal based lipid comprising the organic acid in an animal feed or a pet food.

8. The method according to claim 1, wherein the organic acid is lactic acid.

9-10. (canceled)

11. The method according to claim 1, further comprising mixing a polar antioxidant with the organic acid.

12. A method for preventing oxidation in a lipid, the method comprising:
mixing a lipid soluble organic acid and lecithin with the lipid.

13. The method according to claim 12, wherein the organic acid is selected from the group consisting of lactic acid, succinic acid, citric acid, fumaric acid, malic acid, and combinations of any thereof.

14. The method according to claim 12, further comprising mixing a primary antioxidant with the lipid.

15. The method according to claim 12, further comprising incorporating the lipid comprising the lipid soluble organic acid and the lecithin in an animal feed or a pet food.

16. The method according to claim 12, wherein the lipid soluble organic acid is added at an amount of 0.2-6% by weight of the lipid.

17-18. (canceled)

19. The method according to claim 12, further comprising mixing a polar antioxidant with the lipid soluble organic acid.

20. A lipid containing composition comprising:
a lipid soluble organic acid; and
a lipid;
wherein the lipid containing composition has an improved oxidative stability as compared to a lipid containing composition not including the lipid soluble organic acid.

21. The lipid containing composition of claim 20, further comprising a primary antioxidant.

22. The lipid containing composition of claim 20, further comprising lecithin.

23-24. (canceled)

25. The lipid containing composition of claim 20, wherein the lipid is animal based.

26-27. (canceled)

28. The lipid containing composition of claim 20, further comprising a polar antioxidant.

29-30. (canceled)
